(19) United States
(12) Patent Application Publication
(10) Pub. No.: US 2010/0054001 A1
(43) Pub. Date: Mar. 4, 2010

(54) AC/DC Converter with Power Factor Correction

(76) Inventors: Kenneth Dyer, Davis, CA (US); Sajol Ghoshal, El Dorado Hills, CA (US); Philip John Crawley, Sacramento, CA (US); John Camagna, El Dorado Hills, CA (US)

Correspondence Address: KOESTNER BERTANI LLP, 2192 Martin St., Suite 150, Irvine, CA, 92612, US

(21) Appl. No.: 12/198,802

(22) Filed: Aug. 26, 2008

(51) Int. Cl. H02M 3/335

(52) U.S. Cl. 363/21.17

(57) ABSTRACT

A power converter is configured for usage in a power factor correction system. The power converter comprises a transformer with a primary winding and a secondary winding which isolates a primary side from a secondary side. A primary side switch is coupled to the primary winding. An isolator coupled to the primary side switch isolates the primary side from the secondary side and comprises a signal pathway passing a digital signal from the primary side to the secondary side. Power factor correction circuitry is coupled to the primary side switch and adjusts electric load characteristics to improve power factor toward unity.

### BACKGROUND

Power factor correction (PFC) is a processor for adjusting characteristics of electric loads to improve power factor toward unity (1). Power factor correction is typically applied either by an electric power transmission utility to improved stability and efficiency of the transmission network, or correction may be installed by individual electrical customers to reduce costs charged by the electricity supplier. A suitable power factor is generally sought in a transmission system to reduce transmission losses and improve voltage regulation at the load.

### SUMMARY

An embodiment of a power converter is configured for usage in a power factor correction system. The power converter comprises a transformer with a primary winding and a secondary winding which isolates a primary side from a secondary side. A primary side switch is coupled to the primary winding. An isolator coupled to the primary side switch isolates the primary side from the secondary side and comprises a signal pathway passing a digital signal from the primary side to the secondary side. Power factor correction circuitry is coupled to the primary side switch and adjusts electric load characteristics to improve power factor toward unity.

### BRIEF DESCRIPTION OF THE DRAWINGS

Embodiments of the invention relating to both structure and method of operation may best be understood by referring to the following description and accompanying drawings:

FIGS. 1A and 1B are schematic block and circuit diagrams illustrating embodiments of power converters configured for usage in a power factor correction system;

FIG. 2 is a schematic block and circuit diagram showing an embodiment of a power converter with EMI noise suppression;

FIG. 3 is a schematic block and circuit diagram depicting an embodiment of a power converter that integrates power factor correction with isolation technology;

FIGS. 4A and 4B are schematic circuit and block diagrams showing embodiments of power converters including a power factor correction circuit in a configuration that reduces voltage at the output terminal of the power factor correction circuit and enables reduction in size, and thus cost, of a filter capacitor;

FIGS. 5A through 5D are flow charts showing one or more embodiments or aspects of a method of converting power using power factor correction; and

FIG. 6 is a circuit diagram showing an example of a single-stage power factor correction circuit.

### DETAILED DESCRIPTION

A single-stage or multiple-stage AC/DC converter can include a rectifier, a power factor correction (PFC) controller, and a DC/DC converter. The DC/DC converter can be implemented in any suitable configuration, for example buck, boost, flyback, and the like.

Power factor correction (PFC) is employed to correct power factor to unity.

Power factor correction can be combined with a reduction in voltage following a DC/DC converter to reduce component cost. Power factor correction enables overall component costs to be reduced by enabling selection of optimum voltages. The DC/DC converter can be implemented using a boost/buck approach to attain the voltage reduction, thereby reducing the control voltage at a node connecting a power factor correction circuit, the DC/DC controller and a DC/DC primary. Transformer filter cost, filter capacitor cost, and reliability could be changed by reducing the voltage at the DC/DC converter. Transformer and filter capacitor cost can be reduced and reliability improved by reducing the input voltage to the following DC/DC primary.

Isolation technology can be added to the power converter to integrate PFC system components on primary and secondary system portions, reducing component count and enabling PFC data to be available on the secondary, and further enabling the PFC data to be processed on or outside the secondary actually, such as on a computer connected to the chip.

The isolation technology employs a bidirectional interface for optimum design, supporting bidirectional information flow in processing of power factor correction among the primary, secondary, and external to the primary and secondary, thereby facilitating flexibility and optimal arrangement of functionality.

Because the bidirectional information flow enables communication and availability of load characteristics, the power converter can change operation mode based on load conditions. Load information can be transferred back from the secondary to the primary thus allowing the converter to change mode in such a way as to maximize efficiency. An example is for the AC/DC converter to reduce operating frequency or shut-down periodically when the output load is reduced.

Illustrative power converters can include a control interface that enables primary side telemetry of line voltage, line-current and their spectral properties. The information can be communicated via a GPIO and an I²C interface on the secondary side of the isolation, a feature that enables remote management of AC/DC power-supplies and can form part of an overall digital power-management solution. Detection of brown-outs and poor line voltage conditions can be debugged remotely saving time, effort and money.

The illustrative power converters enable power factor correction over a wide range of input voltages and currents. Secondary side output-load regulation can be implemented without using an opto-coupler. The depicted power converters can also have a remote management capability.

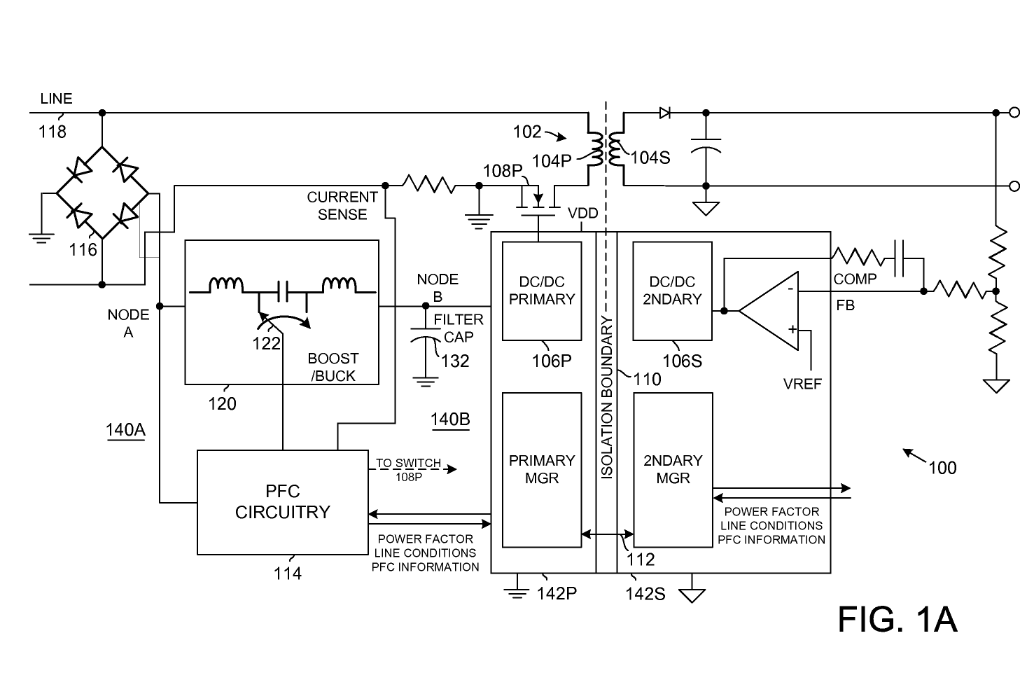

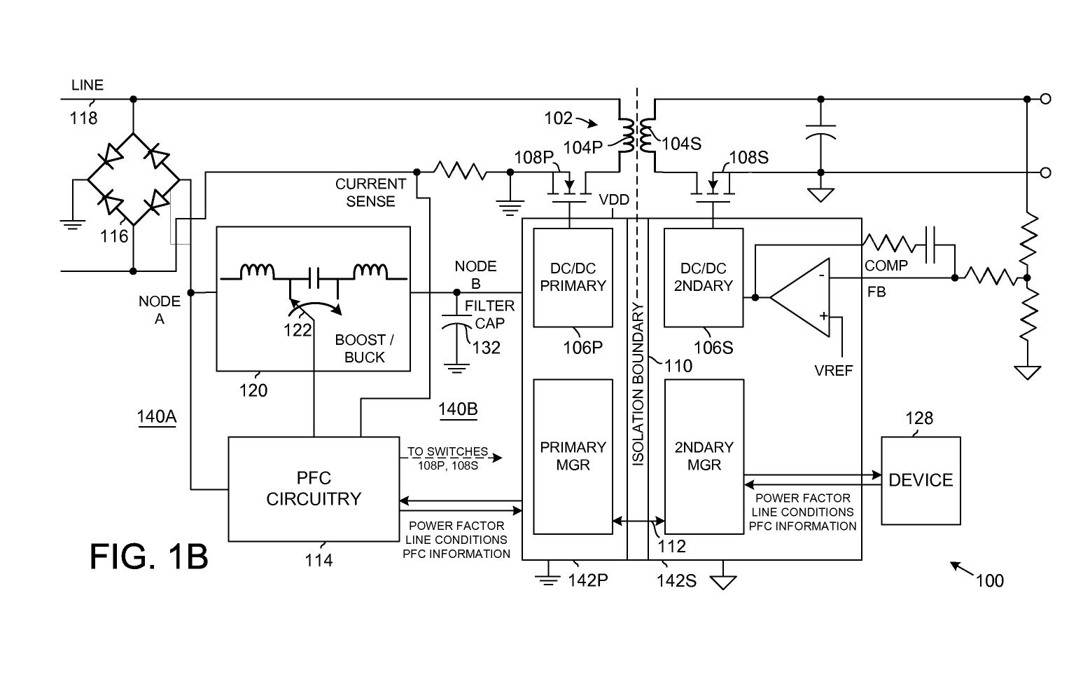

Referring to FIG. 1A, a schematic block and circuit diagram illustrates an embodiment of a power converter 100 configured for usage in a power factor correction system. The power converter 100 comprises a transformer 102 with a primary winding 104P and a secondary winding 104S which isolates a primary side 106P from a secondary side 106S. A primary side switch 108P is coupled to the primary winding 104P. An isolator 110 coupled to the primary side switch 108P isolates the primary side 106P from the secondary side 106S and comprises a signal pathway 112 passing a digital signal from the primary side 106P to the secondary side 106S. Power factor correction circuitry 114 is coupled to the primary side switch 108P and adjusts electric load characteristics to improve power factor toward unity.

The illustrative power converter 100 combines power factor correction (PFC) circuitry 114 with a boost/buck converter. The PFC system employs an isolator 110 with a communication pathway 112 that makes PFC information available to the secondary 106S.

The illustrative power converter 100 can further comprise a rectifier 116 coupled to a line interface 118 at a line voltage. A direct current (DC)/DC converter 120 is shown coupled to the rectifier 116 at the high voltage node and also coupled to the primary side switch 108P. The power factor correction circuitry 114 comprises a control connection 122 to the DC/DC converter 120.

Power factor correction in the power converter 100 ensures that voltage and current track at the converter input terminal with input voltage and current mutually in-phase. Power factor correction is typically defined as the cosine of the angle between the current and the voltage and ideally has a value, called the power factor (PF) of unity (1). Aspects that degrade power factor away from unity include phase shift, distortion, and others.

In various embodiments, one or more DC/DC converters 120 can be coupled to the primary side 106P to form either multiple-stage or single-stage alternating current (AC)/DC converters.

The switch 108P can be controlled by the DC/DC converter 106P and, in another configuration can also be controlled by the PFC circuitry 114, which may be more optimal depending on various conditions.

The DC/DC converter 120 can be an integrated DC-DC converter that operates from a switched input voltage and includes soft-start and current limiting. After the input power and enable signals are asserted, the DC/DC controller starts operating. The converter 120 generates control signals to an external MOSFET switch 108P and can use an external sense resistor to sense the transformer primary current. This current sense is used for both DC/DC operation and measurement of line current.

The DC-DC architecture can be a current mode converter which can be configured with external component changes for either flyback or forward topologies. Both non-isolated and isolated switching technologies are supported. The PWM switching signal can be controlled for low radiated and conducted emissions and optimal power-factor.

Referring to FIG. 1B, a schematic block and circuit diagram depicts an embodiment of a power converter 100 including multiple control switches. In the illustrative implementation, the power converter 100 can further comprise a secondary side switch 108S coupled to the secondary winding 104S. The isolator 110 isolates the primary side 106P from the secondary side 106S coupled between the primary side switch 108P and the secondary side switch 108S and comprises a signal pathway 112 passing a digital signal from the primary side 106P to the secondary side 106S. The power factor correction circuitry 114 is integrated and distributed among the primary side switch 108P and the secondary side switch 108S and adjusts electric load characteristics to improve power factor toward unity.

The inclusion of DC/DC converter 120 operates to reduce filter capacitor voltage. The inclusion of the secondary DC/DC switch 108s can improve power factor correction operation.

In various embodiments, the power factor correction circuitry 114 can be selectively distributed and integrated among the primary side switch 108P, the secondary side switch 108S, and a device 128 coupled to the secondary side switch 108S.

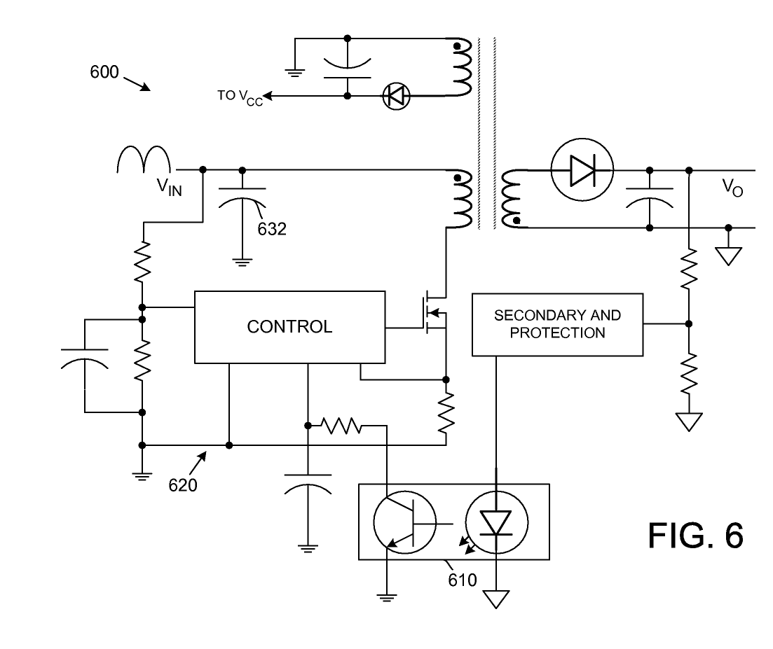

The illustrative power converter 100 can be implemented as an integrated multiple-stage power factor correction (PFC) system. A first stage 140A is labeled node A and the first stage voltage can be in a range between approximately 85 volts and 400 volts. The power factor correction circuitry 114 is coupled between the first stage 140A at node A and a second stage 140B at node B. A filter capacitor 132 and the DC/DC converter 120 are coupled at node B. The output connection of the power factor correction circuitry 114 at node B is typically at a voltage much lower than at node A, for example 48 volts or lower, which enables usage of a filter capacitor 132 which is substantially less expensive than a filter capacitor for usage at high voltage. The illustrative topology of the power converter 100 is a two-stage power factor correction circuit 114. In contrast, a single-stage circuit 600 such as shown in FIG. 6 does not have a second stage similar to node B. For the single-stage power factor correction circuit 600, high voltage enters as shown at the left, passes through a capacitor 632, and then exits on the right of a DCDC converter 620. The single-stage circuit 600 has no intermediate node and thus does not have a reduction in voltage at the output terminal of the power factor correction circuit 614 which enables reduction in cost of the filter capacitor 632 as is attained in the multiple-stage converter 100 depicted in FIGS. 1A and 1B. Accordingly, the power converter 100 has multiple stages enabling a substantial voltage reduction at node B in comparison to node A, thereby reducing component cost at node B.

The bridge rectifier or rectifiers 116, such as shown on the left side of the power converter 100 depicted in FIGS. 1A and 1B, would only draw current from the line interface in a configuration without power factor correction, thus drawing current from the line only when the voltage has peaked on the line. When the voltage is sufficiently low that no current is drawn, then the power factor is unsuitable and the waveform is distorted in terms of current. Typically, the voltage has the form a sine wave but the current is formed in spikes, creating noise on the power lines and in the power system. The phase of harmonics may not be aligned in terms of the current and may not be aligned with the voltage, resulting in reduced power transfer. Inclusion of power factor correction circuits 114 enables current to be drawn from the line 118 in proportion to the voltage. Thus if the voltage in the first stage 140A at node A is low, then current drawn is low. If the voltage in the first stage 140A at node A is high, then the current drawn is high. The power factor correction circuitry 114 tends to scale the current drawn with the input voltage at node A. The configuration shown in FIGS. 1A and 1B generates a cosine absolute value function at node A so that the best power factor enables current to be pulled in proportion to the voltage at node A.

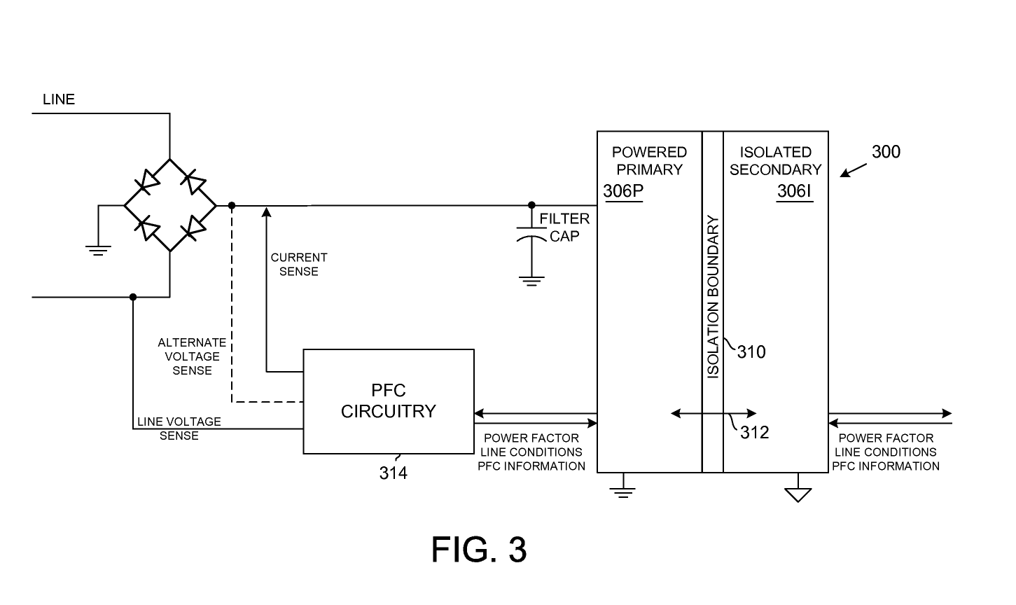

The power converter 100 includes the power factor correction (PFC) circuitry 114 coupled to a DC/DC primary 142P and DC/DC secondary 142S and respective component switching circuits 108P and 108S. The isolation 110 supplies voltage isolation between the primary 142P and secondary 142S. Edge isolation technology, for example as depicted in more detail in FIG. 3, enables communication of information across the isolation barrier which enables control logic to be located at any location interior or exterior to the power converter 100. For example, power factor correction control and functionality can be located not only in the power factor correction (PFC) circuitry 114 but also distributed in the DC/DC primary 142P and DC/DC secondary 142S, and even external to the power converter 100 such as an external processor, computer, or other control logic. Accordingly, only a portion of PFC control can be implemented in the PFC circuitry 114 and other portions distributed in other structures depending on various considerations. For example, circuits in primary and secondary dies can be reused to perform portions of PFC functionality so that the power factor correction system can be at least partly implemented with components that exist already on primary and secondary dies across the isolation barrier. Isolation technology that supports bidirectional communication in various forms enables flexibility and improved control capabilities. For example, various types of information relating to power factor correction, for example coefficients or aspects of the line, such as line voltage ripple, can be extracted from power factor correction. FIGS. 1A and 1B show arrows that depict bidirectional communication between the PFC circuitry 114 and the DC/DC primary 142P to indicate that information can be sent among the PFC circuitry 114, the DC/DC primary 142P, the DC/DC secondary 142S, and to external devices in communication with the DC/DC secondary 142S. Thus, an external device or controller has a capability to communicate with the power converter 100 and request information about power factor on the primary 142P, and the power converter 100 can return the information. A capability to send power factor and line information across the isolation barrier 110 using bidirectional communication enables enhanced computation and control either on the secondary 142S or external to the power converter 100. The illustrative communication across the isolation barrier 110 enables offloading of power factor correction functionality from the power converter 100 and substantial simplification of the internal PFC circuitry 114 so that large, power-consuming components such as digital signal processors can be omitted from the power converter 100 with no reduction in functionality. Potentially, all PFC functionality can be performed externally from the primary side 142P by communication. PFC functionality thus can be located on the secondary side 142S or to an external computer or hardware that is used for other functionality to be configured for controlling the power factor.

In some embodiments, the power converter 100 can include a communication interface, for example an I²C interface that enables telemetry of signals on the primary such as input voltage, input current, power-factor correction for digital remote power-management applications. The interface enables remote management and debug of power systems for highest overall energy efficiency.

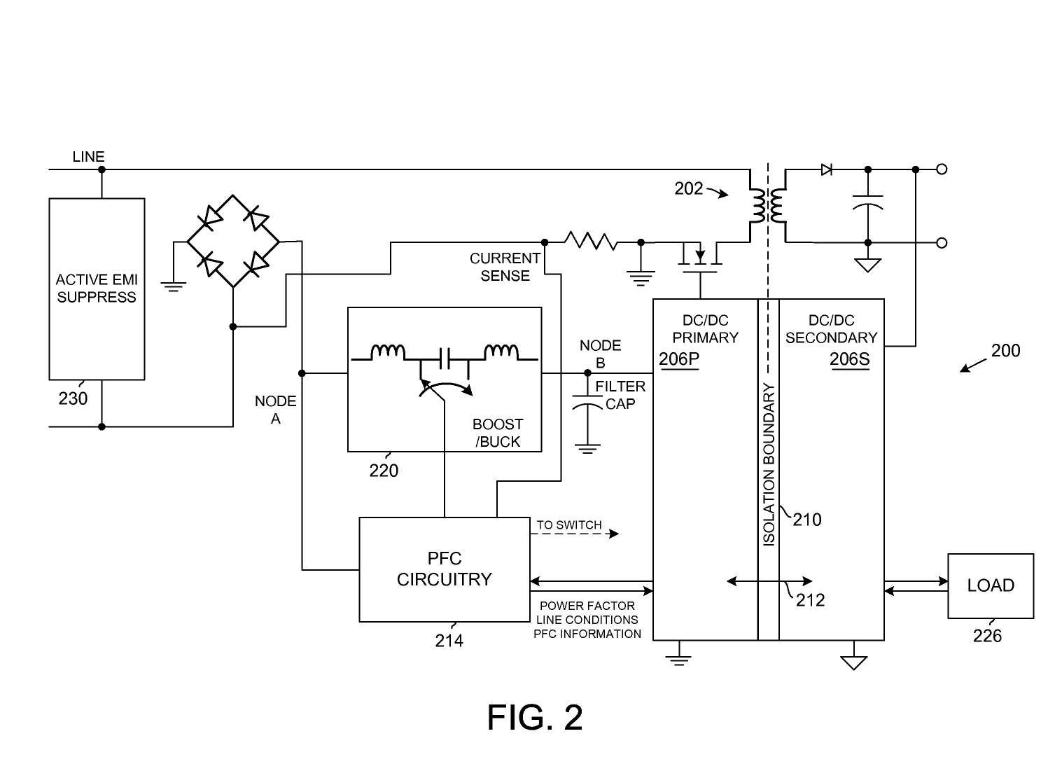

A power converter can be configured to address both EMI emission concerns and surge/over-voltage protection in AC/DC applications. Referring to FIG. 2, a schematic block and circuit diagram depicts an embodiment of a power converter 200 with EMI noise suppression. In the illustrative implementation, the power converter 200 can further comprise a common mode suppression and electrostatic discharge protection circuit 230 coupled to the transformer 202 that rejects electromagnetic interference (EMI) noise. A digital signal on the signal pathway 212 across the isolator 210 communicates secondary side information to the primary side 206P for usage on the primary side 206P for reducing or minimizing EMI and improving power factor toward unity.

The illustrative isolated digital approach to the power converter 200 facilitates inclusion of the common mode suppression and electrostatic discharge protection circuit 230 for EMI reduction which applies a technique such as clock spreading to reduce the cost of the magnetics. Isolation enables communication of information from the secondary side 206S to the primary side 206P that enables the primary 206P to reduce or minimize EMI in addition to improving power factor to unity. The active EMI suppression circuit 230 increases the EMI suppression of other circuit elements, such as switching of the Boost/buck (in a cascade) or the DC/DC Primary (in a single-stage) that can also reduce EMI.

The common mode suppression and electrostatic discharge protection circuit 230 can be integrated as a separate device or as part of the power factor correction circuitry 214.

The power converter 200 can further comprise the power factor control circuitry 214 in combination with at least one DC/DC converter 220 coupled to the primary side 206P and a load 226 coupled to the secondary side 206S. The common mode suppression and electrostatic discharge protection circuit 230 coupled to the transformer 202 rejects electromagnetic interference (EMI) noise. A digital signal on the signal pathway 212 across the isolator 210 can communicate load condition information and supply harmonics from the secondary side 206S to the primary side 206P for usage on the primary side 206P for controlling operating characteristics of the one or more DC/DC converters 220.

Although the EMI suppression circuitry 230 is depicted separately, the circuitry 230 also can be at least partially integrated into the PFC circuitry 214 since harmonic distortion in the line-current reduces power-factor. Power-factor correction circuits reduce harmonic distortion. The reduction in distortion and higher order harmonics reduces EMI. In a particular example, EMI suppression can be implemented with a spread-spectrum clock on the Boost/Buck 120 shown in FIG. 1A or the primary in FIG. 3.

Referring to FIG. 3, a schematic block and circuit diagram depicts a single-stage embodiment of a power converter 300 that integrates power factor correction with isolation technology. The illustrative power converter 300 and power factor correction system employ a bidirectional interface for optimal design with bidirectional information flow that gives flexibility in design. Information about power factor (PF) can be communicated across the isolation 310.

The power converter 300 comprises a powered system 306P and an isolated system 3061 that bidirectionally communicates with the powered system 306P. A power factor correction circuit 314 coupled to the powered system 306P adjusts electric load characteristics to improve power factor toward unity. A signal pathway 312 passes a digital signal from the powered system 306P to the isolated system 306I and communicates the digital signal bidirectionally among the powered system 306P, the isolated system 306I, and a device 328 coupled to the isolated system 306I. The input connection to the PFC circuitry line passing to the filter capacitor is a current sense line. The PFC 314 operates using current sense and voltage sense. The voltage can be sensed on the line directly coupled to the rectifier or connected after the rectifier. The current is typically sensed after the rectifier bridge as shown. In an example implementation, a small resistor can be connected in series with the diode bridge. Current is typically sensed in a sensing circuit with a resistor.

The signal pathway 312 can communicate power factor information bidirectionally among the power factor correction circuit 314, the powered system 306P, and the isolated system 306I. Because the power factor correction circuit 314 measures both line current and voltage, information about both current and voltage, including harmonics, is also available via the bidirectional interface and the signal pathway 312.

The bidirectional signal pathway 312 enables communication of information, including control information, in both directions between the primary 306P and secondary 306S across the isolation barrier 310. In contrast, the circuit 600 shown in FIG. 6 includes an optical coupler to communicate information in a feedback-only connection. Information from the optical output Vo is only fed back to the DC/DC converter 620. Information does not travel both ways between the primary and the secondary. The lack of bidirectional communication capability in the power converter 600 between the primary and secondary other than simple feedback of voltage forces power factor correction to be located on the high-voltage primary side, substantially increasing system cost. Accordingly, inclusion of logic sufficient for power factor control functionality, such as a microprocessor, complex logic, or digital signal processor, onto circuits in the high-voltage environment of the primary side is very costly, particularly in comparison to a low voltage CMOS process that can be implemented on a low-voltage secondary side.

By using high-volume standard CMOS technology, higher performance single-stage power-factor correction AC/DC converters can be implemented with low cost and a small footprint.

The capability to distribute the power factor correction functionality internal and external to the power converter of the various embodiments shown in FIGS. 1A, 1B, 2, 3, 4A, and 4B enables an increase in functionality and reduced cost to attain a best performance-to-cost ratio.

The example power converter 600 shown in FIG. 6 is configured as a boost converter 620 with the line voltage connected directly to the filter capacitor 632. The converter 600 has an optical isolator 610 which is unidirectional so that PFC information is not available on secondary.

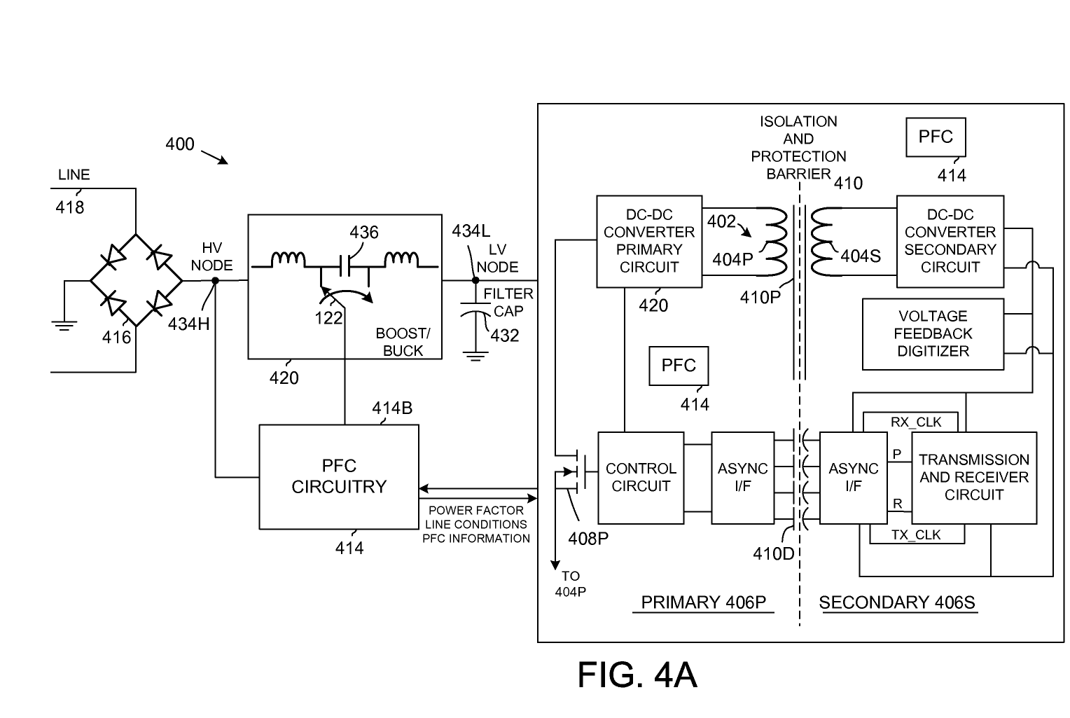

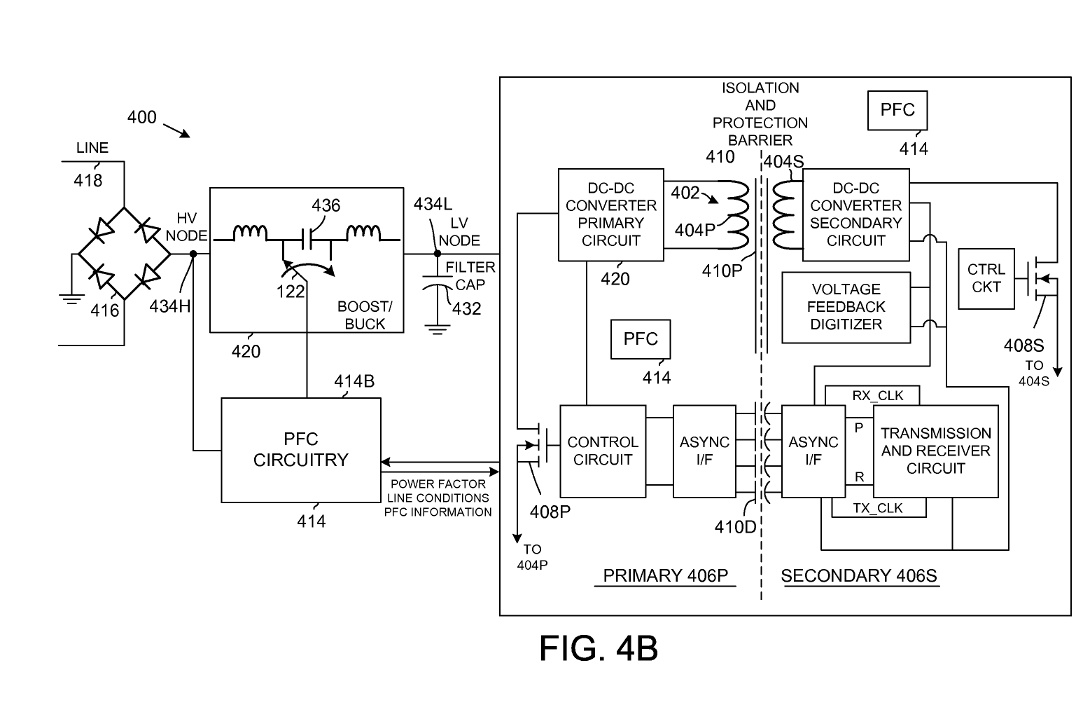

Referring to FIG. 4A, a schematic circuit and block diagram shows an embodiment of a power converter 400 including power factor correction circuitry 414 in a configuration that reduces voltage at the output terminal of the power factor correction circuit 414 and enables reduction in size, and thus cost, of a filter capacitor 432. Power converter 400 has distributed power factor correction circuitry 414 among a primary side 406P, a secondary side 406S, and possibly to devices such as computers and controllers external to the power converter 400. The distributed power factor correction circuitry 414 communicates via a bidirectional channel, for example the illustrative asynchronous interface channel.

The PFC 414 can operate using current sense and voltage sense. The voltage sense line is shown coupled to the high voltage node 434H. The current sense line is not shown and typically can be supplied by a DC/DC controller in the primary side 406P.

A power transfer isolation barrier 410P that is configured to transfer power while maintaining isolation between the powered system 406P and the isolated system 406S. A digital isolation barrier 410D distinct from the power isolation barrier 410P communicates digital communication signals between the powered system 406P and the isolated system 406S.

The illustrative power converter 400 comprises a DC/DC converter 420 coupled to a high voltage node 434H, a power factor correction circuit 414 coupled to the high voltage node 434H and also coupled to the DC/DC converter 420, and a transformer 402 comprising a primary winding 404P and a secondary winding 404S and isolates a primary side 406P from a secondary side 406S. A primary side switch 408P is coupled to the primary winding 404P and coupled to the DC/DC converter 420 at a low voltage node 434L at a voltage lower than the high voltage node 434H and coupled to the power factor correction circuit 414 at the low voltage node 434L. An isolator 410 coupled to the primary side switch 408P isolates the primary side 406P from the secondary side 406S. A filter capacitor 432 is coupled to the low voltage node 434L. The reduction in voltage from the high voltage node 434H to the low voltage node 434L enables a reduction in filter capacitor cost and an increase in reliability.

The configuration of the power converter 400 enables flexibility in distributing circuits on the primary side 406P and the secondary side 406S. The primary side 406P is exposed to large voltages. For example in some applications, the power factor correction circuit block 414B can be exposed to voltages of 400 volts. However, the components the secondary side 406S could be on a much lower voltage integrated circuit, for example a 5 volt or less chip such as 3.3V, 2.5V, 1.8V, or other regulators. Accordingly, a design can attain advantages of a deep submicron process on the secondary 406S which communicates with high voltage power factor correction circuitry 414B on the primary 406P.

The configuration of the filter capacitor 432 and the DC/DC converter 420 on node B enables the voltage to be reduced at node B and reduction in cost, and typically size, of the capacitor 432. A capacitor suitable for high voltage usage is typically costly so that reduction in cost of the component is highly beneficial.

In some embodiments, the power converter 400 can further comprise a rectifier 416 coupled to a line interface 418 at the line voltage. The DC/DC converter 420 is coupled to the rectifier 416 at the high voltage node 434H.

In some embodiments the DC/DC converter 420 can be a boost-buck converter formed of cascaded boost step-up and buck step-down converters. The DC/DC converter 420 has an output voltage magnitude that is less than the input voltage magnitude. The boost-buck converter combines a boost and a buck function in one component. The boost aspect at the input terminal of the DC/DC converter 420 facilitates operation of the power factor correction circuit 414 while the buck aspect enables a reduction in voltage at the DC/DC converter output terminal and a reduced voltage at the filter capacitor 432.

In an example embodiment, the DC/DC converter 420 can be a Cuk converter. The Cuk converter is a combination of a boost and a buck in one structure that has an output voltage magnitude that is either greater than or less than the input voltage magnitude, with an opposite polarity. The CUK converter is desirable on the basis of combined boost and buck operation, a highly flexible arrangement in which the input voltage is loaded on an inductor which can attain the best power factor correction.

The boost-buck converter 420 has an internal capacitor 436 that is prohibited from having a voltage greater than the voltage at the low voltage node 434L. Voltage is increased or boosted on the left side of the capacitor 436 and reduced on the right side.

While the DC/DC converter 420 can be implemented in any suitable architecture, boost and buck functionality are useful for reducing filter capacitor cost.

In some embodiments, the power converter 400 can be a multiple-stage AC/DC converter.

In an illustrative embodiment, the primary side 406P and power factor correction circuit 414 are exposed to the high voltage that is substantially higher than the low voltage at the low voltage node 434L and the secondary side 406S includes deep submicron process circuits that communicate with the power factor correction circuit 414 at the high voltage on the primary side 406P.

The high voltage at the primary side 406P is higher than 48 volts or higher, typically significantly higher such as 90 volts or above, and the low voltage at the secondary side 406S is 48 volts or lower wherein the high voltage and the low voltage are selected to reduce overall component cost.

Referring to FIG. 4B, a schematic block and circuit diagram depicts an embodiment of a power converter 400 including a multi-control switch. In the illustrative implementation, the power converter 400 can further comprise a secondary side switch 408S coupled to the secondary winding 404S. The isolator 410 isolates the primary side 406P from the secondary side 406S coupled between the primary side switch 408P and the secondary side switch 408S.

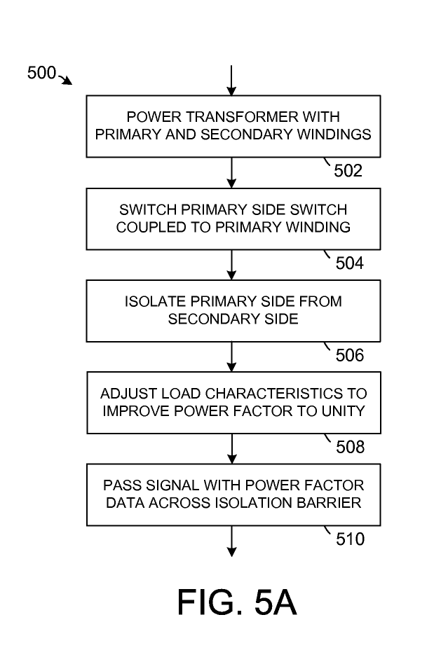

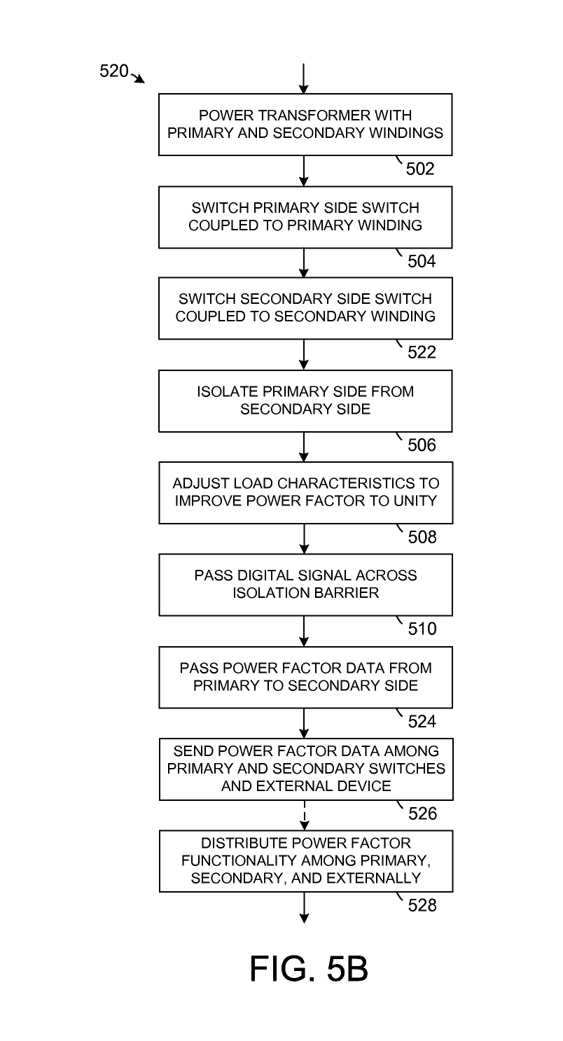

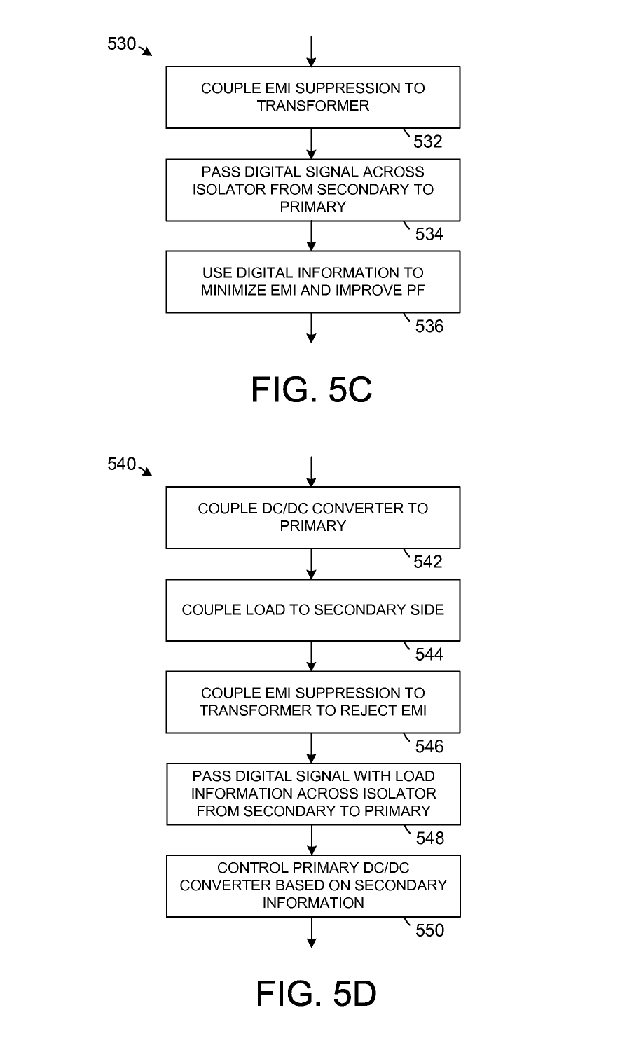

FIGS. 5A through 5D are flow charts showing one or more embodiments or aspects of a method of converting power using power factor correction. Referring to FIG. 5A, a power conversion method 500 comprises applying 502 power to a transformer comprising a primary winding and a secondary winding that isolates a primary side from a secondary side, switching 504 a primary side switch coupled to the primary winding, and isolating 506 the primary side from the secondary side at an isolation barrier. Electric load characteristics are adjusted 508 to improve power factor toward unity by power factor correction. A digital signal is passed 510 bidirectionally on a signal pathway over the isolation barrier between the primary side and the secondary side with the digital signal including power factor information.

Referring to FIG. 5B, another power conversion method 520 can further comprise switching 522 a secondary side switch coupled to the secondary winding and passing 524 the power factor information from the primary side to the secondary side, and communicating 526 the power factor information bidirectionally among the power factor correction circuit, the primary side switch and the secondary side switch, and a device coupled to the secondary side switch.

In some embodiments, power factor functionality can be distributed and integrated 528 among the power factor correction circuit, the primary side switch, the secondary side switch, and/or a device coupled to the secondary side switch.

Referring to FIG. 5C, a method 530 for power conversion can further comprise coupling 532 a common mode suppression and electrostatic discharge protection circuit to the transformer which rejects electromagnetic interference (EMI) noise. A digital signal can be passed 534 on the signal pathway across the isolator communicating secondary side information to the primary side. Secondary side information is used 536 to reduce or minimize EMI and improve power factor toward unity on the primary side.

Referring to FIG. 5D, a method 540 for power conversion can further comprise coupling 542 at least one DC/DC converter to the primary side, coupling 544 a load to the secondary side, and coupling 546 a common mode suppression and electrostatic discharge protection circuit to the transformer that rejects electromagnetic interference (EMI) noise. A digital signal is passed 548 on the signal pathway across the isolator communicating load condition information from the secondary side to the primary side. The primary side operating characteristics of the at least one DC/DC converter are controlled 550 based on the secondary side load condition information.

In some embodiments, under-voltage lockout and open-loop protection can be included for safe and robust power converter design.

The illustrative power converters are useful for various applications such as high-current battery chargers, front-ends for distributed power systems, high-efficiency server and desktop power supplies, telecom rectifiers, PFC flyback converters, and others.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, component values, integrated circuit process variations, temperature variations, rise and fall times, and/or thermal noise. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, various aspects or portions of a network interface are described including several optional implementations for particular portions. Any suitable combination or permutation of the disclosed designs may be implemented.

What is claimed is:

1. A power converter comprising:
a transformer comprising a primary winding and a secondary winding that isolates a primary side from a secondary side;
a primary side switch coupled to the primary winding;
an isolator isolating the primary side from the secondary side coupled to the primary side switch and comprising a signal pathway passing a digital signal from the primary side to the secondary side; and
power factor correction circuitry coupled to the primary side switch that adjusts electric load characteristics to improve power factor toward unity.

2. The converter according to claim 1 further comprising:
a secondary side switch coupled to the secondary winding;
the isolator isolating the primary side from the secondary side coupled between the primary side switch and the secondary side switch and comprising a signal pathway passing a digital signal from the primary side to the secondary side; and
the power factor correction circuitry integrated and distributed among the primary side switch and the secondary side switch and adjusts electric load characteristics to improve power factor toward unity.

3. The converter according to claim 2 further comprising:
the power factor correction circuitry distributed and integrated among the primary side switch, the secondary side switch, and a device coupled to the secondary side switch.

4. The converter according to claim 1 further comprising:
a rectifier coupled to a line interface at a line voltage; and
a direct current (DC)/DC converter coupled to the rectifier at the high voltage node and coupled to the primary side switch, the power factor correction circuitry comprising a control connection to the DC/DC converter.

5. The converter according to claim 1 further comprising:
at least one direct current (DC)/DC converter coupled to the primary side to form a multiple-stage or single-stage alternating current (AC)/DC converter.

6. The converter according to claim 1 further comprising:
a common mode suppression and electrostatic discharge protection circuit coupled to the transformer that rejects electromagnetic interference (EMI) noise, wherein a digital signal on the signal pathway across the isolator communicates secondary side information to the primary side for usage on the primary side for reducing or minimizing EMI and improving power factor toward unity.

7. The converter according to claim 1 further comprising:
at least one direct current (DC)/DC converter coupled to the primary side;
a load coupled to the secondary side; and
a common mode suppression and electrostatic discharge protection circuit coupled to the transformer that rejects electromagnetic interference (EMI) noise, wherein a digital signal on the signal pathway across the isolator communicates load condition information from the secondary side to the primary side for usage on the primary side for controlling operating characteristics of the at least one DC/DC converter.

8. A power converter comprising:
a powered system;
an isolated system that bidirectionally communicates with the powered system;
a power transfer isolation barrier that transfers power while maintaining isolation between the powered system and the isolated system;
a digital isolation barrier distinct from the digital isolation barrier that communicates digital communication signals between the powered system and the isolated system;
a power factor correction circuit coupled to the powered system that adjusts electric load characteristics to improve power factor toward unity.

9. The converter according to claim 8 further comprising:
a signal pathway passing a digital signal from the powered system to the isolated system and communicating the digital signal bidirectionally among the powered system, the isolated system, and a device coupled to the isolated system.

10. The converter according to claim 8 further comprising:
a signal pathway communicating power factor information bidirectionally among the power factor correction circuit, powered system, and the isolated system.

11. A power converter comprising:
a direct current (DC)/DC converter coupled to a high voltage node;
a power factor correction circuit coupled to the high voltage node and coupled to the DC/DC converter;
a transformer comprising a primary winding and a secondary winding and isolating a primary side from a secondary side;
a primary side switch coupled to the primary winding and coupled to the DC/DC converter at a low voltage node at a voltage lower than the high voltage node and coupled to the power factor correction circuit at the low voltage node;
an isolator coupled to the primary side switch and isolating the primary side from the secondary side; and
a filter capacitor coupled to the low voltage node, the reduction in voltage from the high voltage node to the low voltage node enabling a reduction in filter capacitor cost and an increase in reliability.

12. The converter according to claim 11 further comprising:
a secondary side switch coupled to the secondary winding; and
the isolator isolating the primary side from the secondary side coupled between the primary side switch and the secondary side switch.

13. The converter according to claim 11 further comprising:
a rectifier coupled to a line interface at the line voltage; and
the direct current (DC)/DC converter coupled to the rectifier at the high voltage node.

14. The converter according to claim 11 further comprising:
the direct current (DC)/DC converter comprising a boost-buck converter formed of cascaded boost step-up and buck step-down converters.

15. The converter according to claim 11 wherein:
the power converter is a multiple-stage alternating current (AC)/direct current (DC) converter.

16. The converter according to claim 11 wherein:
the primary side and power factor correction circuit are exposed to the high voltage that is substantially higher than the low voltage at the low voltage node; and
the secondary side comprises deep submicron process circuits that communicate with the power factor correction circuit at the high voltage on the primary side.

17. The converter according to claim 11 wherein:
the high voltage at the primary side is higher than 48 volts or higher and the low voltage at the secondary side is 48 volts or lower wherein the high voltage and the low voltage are selected to reduce overall component cost.

18. The converter according to claim 11 further comprising:
the direct current (DC)/DC converter comprising a Cuk converter.

19. A method of converting power comprising:
applying power to a transformer comprising a primary winding and a secondary winding that isolates a primary side from a secondary side;
switching a primary side switch coupled to the primary winding;
isolating the primary side from the secondary side at an isolation barrier;
adjusting electric load characteristics to improve power factor toward unity by power factor correction; and
passing a digital signal bidirectionally on a signal pathway over the isolation barrier between the primary side and the secondary side, the digital signal including power factor information.

20. The method according to claim 19 further comprising:
switching a secondary side switch coupled to the secondary winding; and
passing the power factor information from the primary side to the secondary side and communicating the power factor information bidirectionally among the power factor correction circuit, the primary side switch and the secondary side switch, and a device coupled to the secondary side switch.

21. The method according to claim 20 further comprising:
distributing and integrating power factor functionality among the power factor correction circuit, the primary side switch, the secondary side switch, and/or a device coupled to the secondary side switch.

22. The method according to claim 19 further comprising:
coupling a common mode suppression and electrostatic discharge protection circuit to the transformer that rejects electromagnetic interference (EMI) noise;
passing a digital signal on the signal pathway across the isolator communicating secondary side information to the primary side; and
using the secondary side information to reduce or minimize EMI, and improve power factor toward unity on the primary side.

23. The method according to claim 19 further comprising:
coupling at least one direct current (DC)/DC converter to the primary side;
coupling a load to the secondary side;
coupling a common mode suppression and electrostatic discharge protection circuit to the transformer that rejects electromagnetic interference (EMI) noise;
passing a digital signal on the signal pathway across the isolator communicating load condition information from the secondary side to the primary side; and
controlling the primary side operating characteristics of the at least one DC/DC converter based on the secondary side load condition information.
